(19) United States
(12) Patent Application Publication
(10) Pub. No.: US 2009/0100138 A1
(43) Pub. Date: Apr. 16, 2009

(54) Spam filter

(76) Inventor: Scott C. Harris, Rancho Santa Fe, CA (US)

Correspondence Address: SCOTT C HARRIS, P O BOX 927649, SAN DIEGO, CA, 92192, US

(21) Appl. No.: 10/890,721

(22) Filed: Jul. 13, 2004

Related U.S. Application Data
(60) Provisional application No. 60/488,672, filed on Jul. 18, 2003.

(51) Int. Cl. G06F 15/82

(52) U.S. Cl. 709/206

(57) ABSTRACT

Detection of undesired electronic communication, such as spam emails, by comparing the email with a list of likely spam words and establishing the communication as undesired when the words in the list, are substantially present in the email, even if not completely present. For example, the match is close enough if the words have similar letters in similar orders, but with other letters separating them. Another aspect matches the words with a dictionary or rules defining spelling for the language. Emails with too high a percentage of garbage words are marked as undesirable.

This claims priority to Provisional Application No. 60/488,672, filed Jul. 18, 2003.

### BACKGROUND

My co-pending applications (Ser. Nos. 09/682,599 and 09/690,002) describe systems which use a set of rules to determine whether an email is undesired, or ‘spam’. In one embodiment, which may be used with the presently disclosed system, an e-mail is received, read, deleted, or otherwise moved. Another option, however, is to delete the e-mail in a way which indicates to the system that the message is in fact spam, effectively a “delete as spam” button. The system takes those spam e-mails, and processes rules on those spam e-mails.

The end result is a number of rules which define which messages are spam. Since the user may individually select the different criteria, these rules can be individually configured for the user's specific desires.

### SUMMARY

This application describes a spam filter intended to be used to identify junk mail or undesired mail, and may allow actions to filter the undesired email.

### BRIEF DESCRIPTION OF THE DRAWINGS

FIG. 1 shows a block diagram of the present specification.

### DETAILED DESCRIPTION

Senders of undesired e-mails or spammers, have determined different ways to prevent spam identifiers from identifying the email as being undesired. The present system describes additional rules and techniques which may be used as counteractions.

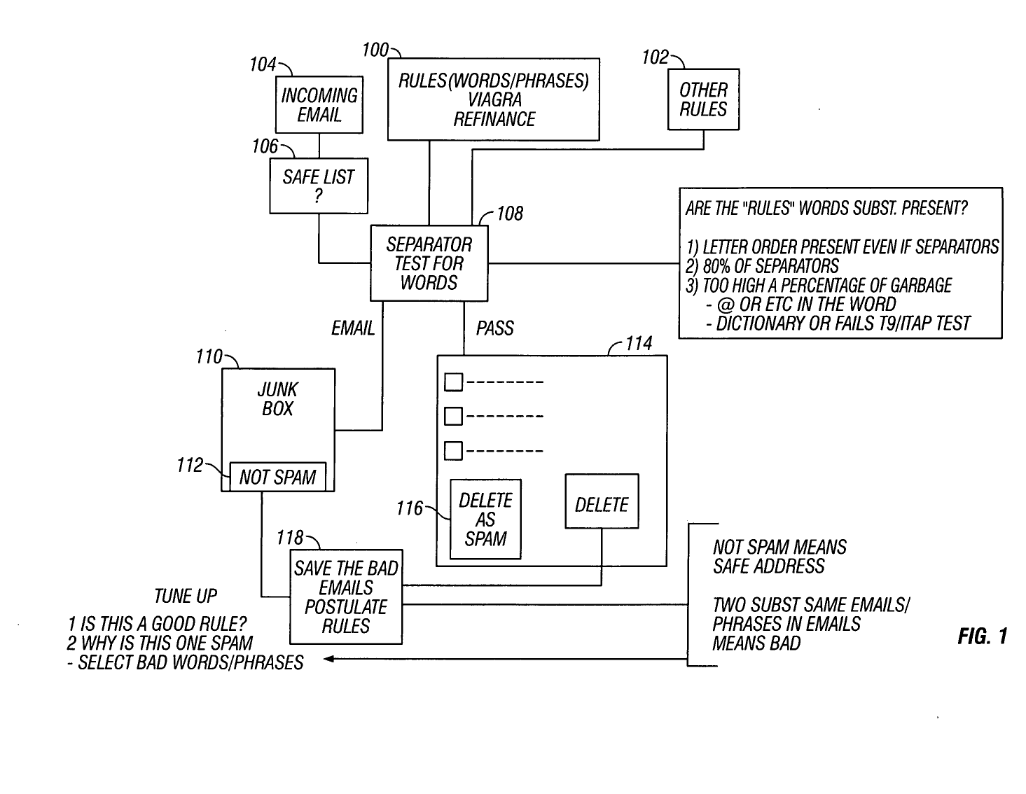

According to this system, a rules-based system which looks for specified words, phrases or characteristics of an electronic communication, e.g. an e-mail, is used. FIG. 1 shows an exemplary system, with a set of rules 100 which define words and phrases which are likely to be present in undesired e-mails. While this may change over time, typical words include ‘Viagra’, ‘refinance’, and certain phrases relating to pornographic sites. Other rules, shown as 102 may also be defined. For example the other rules may relate to the form of the e-mail, e.g., whether the e-mail originates from undesirable locations, such as from an Asian country and includes Asian or other non-English-language script.

An incoming e-mail is shown as being received at 104. Initially, that incoming e-mail is screened at 106 to determine whether some aspect of that email is on a “safe list”. The safe list may be from anyone on contact lists as determined both by the return address and identification from the e-mail. This is used to avoid false detection from senders who often mask their real address. Another item on the safe list may be a list of anyone to whom the user has ever sent an e-mail. Such a list may be included as part of the rules 100. If the incoming e-mail is not on the safe list, however, then a separator is used to test for certain rules, as in my co-pending application(s).

It is recognized that the senders of undesired emails have spoofed filters like this, using even a single wrong or missed character in each word. The present application defines “test for” rules which determine whether the words that form those rules are “substantially present”. The substantially present test may be carried out in various ways.

One way in which the spammers have been fooling filters is to provide words which would be recognized at a glance as being the specified words, but have additional or missing characters therein. Accordingly, a first test may include determining whether the letter order is present even if separated.

A second test may be whether some specified percentage, say 80%, of the letter order is present, even if separated by other characters, e.g., by using an engine that checks documents for typographical errors to check the content of the communication.

Another test which can be carried out, which is not specifically a rule, may include determining too high a percentage of “garbage words” in the e-mail. Garbage words can be detected by too many punctuation marks within the words, and also can be detected by comparing the words with a dictionary. The dictionary can be a real dictionary, or rules based on a simulated dictionary such as the ITap algorithm or T9 algorithm, of the type which are used for entering information into cellular phones, and which include a spelling algorithm that is based on spelling rules of the language of the communication.

The separator test separates messages into pass and fail. Messages which fail are placed into the junk box, and the user has the option of indicating those messages as being authorized messages by actuating the “not spam” button. The system may then respond by asking the user why the e-mail is not spam. Typically the system would provide the user with a number of choices for example, “WHY IS THIS NOT SPAM?” The choices may include “IT IS FROM A MAILING LIST”, “THERE IS IN FACT A FORBIDDEN WORD IN IT, BUT THAT FORBIDDEN WORD WAS SIMPLY PART OF A CONVERSATION”, or “I DON'T EXACTLY KNOW”.

Messages which pass are placed into the pass box 114, and the user is given the option to delete these messages as being spam. Again, the user is given the option to explain why the message is spam. Options may include there is a forbidden word, or simply allow the system to catalog the different e-mails.

At 118, the emails are stored with their status, and the system postulates rules. For example, if the message is indicated as not being spam, then this may mean a safe address. Messages having substantially the same content, within those which have been deleted as spam, may represent that those phrases within the e-mails may trigger a detection of spam. These rules are added to the rule-base 100. The rule-base 100 may be displayed to the user at any time to allow the user a tuneup; specifically is this a good rule? and if not, what might be a better rule.

Other embodiments are possible. For example, this system could be used in any

1. A system, comprising:
a first part for receiving an electronic communication; and
a second part for testing said electronic communication to determine if said electronic communication is undesired based on the presence of specified electronic content, wherein said electronic content includes specified words with letters in specified orders forming a specified letter order, wherein said testing comprises determining that specified undesired electronic content is present if 80% or more, but less than 100%, of the specified letter order is present within the electronic communication.

2. A system as in claim 1, wherein said testing comprises storing a list of undesired electronic content, and said determining comprises comparing the electronic communication with words in the list, and establishing undesired electronic content as present when only a portion of a word less than the entire word in the electronic communication matches with a corresponding portion of a word on the list.

3. A system as in claim 2, wherein said list of undesired electronic content is a list of content which is commonly present in undesired communication, where said content includes at least one of words or phrases, and said testing comprises determining if said content is substantially present in the electronic communication, and establishing said communication as undesirable when only a portion of said content less than the entire content is present and when the exact content is not present.

4. A system as in claim 3, wherein said establishing comprises establishing a word within the content as present even when there is a wrong character or missed character in the word.

5. (canceled)

6. (canceled)

7. A system as in claim 2, wherein said establishing comprises determining whether a word is present with a typographical error therein.

8. A system as in claim 1, wherein said second part operates to determine words within the electronic communication which are not within a language of the electronic communication, and to establish the communication as undesired when too high a percentage of said words which are not within the language are detected.

9. A system as in claim 8, wherein the second part detects the words that are not within the language by comparing it with a dictionary.

10. A method, comprising:
receiving an electronic communication;
detecting the presence of words which are not in a language of the electronic communication; and
determining the electronic communication is undesirable by determining that there are words which are not in the language of the electronic communication, and using the existence of said words which are not in the language of the communication to establish that said communication is undesirable.

11. (canceled)

12. A method as in claim 10, wherein said determining comprises comparing said words which are not in the language with words which represent likely undesired electronic communications, and determining substantial similarities therebetween.

13. A method as in claim 12, wherein said substantial similarities comprise determining whether specified letter order is present but separated

14. A method as in claim 12, wherein said substantial similarities comprise detecting a single wrong character or single missed character in each word.

15. A method as in claim 10, wherein said detecting comprises comparing the words with a dictionary.

16. A method as in claim 10, wherein said detecting comprises comparing the words with rules that are based on a spelling rule of the language.

17. A method, comprising:
receiving an electronic communication;
comparing words within the electronic communication with a list of words that represent at least one of words or phrases that are likely to represent undesired electronic communication; and
establishing the electronic communication is likely being undesirable when either (a) the words match the list of words, or (b) when the words do not match the list of words but differ therefrom only by a specified percentage less than 100%.

18. (canceled)

19. A method as in claim 17, wherein said establishing comprises using a specified percentage of substantially 80%.
